(19) United States
(12) Patent Application Publication
(10) Pub. No.: US 2013/0282523 A1
(43) Pub. Date: Oct. 24, 2013

(54) NETWORK SERVICE PROVIDER ASSISTED PAYMENT FRAUD DETECTION AND MITIGATION METHODS AND APPARATUS

(71) Applicants: Howard Pfeffer, Reston, VA (US); Peter Stern, Riverside, CT (US)

(72) Inventors: Howard Pfeffer, Reston, VA (US); Peter Stern, Riverside, CT (US)

(21) Appl. No.: 13/452,797

(22) Filed: Apr. 20, 2012

(51) Int. Cl. G06Q 40/02; G06Q 30/06

(52) U.S. Cl. 705/26.35; 705/44

(57) ABSTRACT

Fraud detection and/or detection of discrepancies between customer provided information and reliable information corresponding to a customer are described. The methods and apparatus are particularly well suited for Internet and/or other E-commerce transactions. A payment company, e.g., a credit card/debit card provider, as part of a transaction authorization, sends a query to a customer's ISP with some information corresponding to the payer/customer requesting the transaction (e.g. name, billing address, etc.) and the source IP address the customers is using during the transaction. The source IP address is used by the ISP provider to identify a device and/or physical location using the IP address and a customer record corresponding to the device/physical location using the IP address. In at least some embodiments the ISP returns a “matching score” based on how well the customer information matches information in the ISP's customer information record corresponding to the identified location.

### FIELD OF THE INVENTION

The present invention relates to methods and apparatus which support online payment fraud and/or discrepancy detection with the assistance of a network service provider, e.g., internet service provider (ISP), thereby mitigating online payment frauds, e.g., credit card online payment frauds.

### BACKGROUND OF THE INVENTION

In the last few years, online shopping has gained tremendous popularity and has become very common. It is very common for individuals to shop online using various e-commerce websites which maintain a large online inventory of items for the customers to select from. For online sellers, the cost of putting out the items in malls/outlets, and/or other logistics related costs can be greatly reduced as compared to what are sometimes referred to as traditional “brick and mortar” stores.

However with the increase in the number of online buyers/customers, the number of people attempting online fraud and/or fraudulently using payment information corresponding to another customer by stealing customer's payment information, e.g., credit card numbers and/or other payment information, has also increased.

In view of the above discussion, it should be appreciated that it would be desirable if methods and/or apparatus could be developed which would allow authenticating the customer and/or the customer's location at the time when the online order is being placed.

In particular, it would be desirable if a seller could obtain at least some verification of the location from which an order was being placed and/or have at least some user provided information verified from a reliable source as part of an E-commerce transaction with a reasonable degree of certainty that the verification is based, at least particularly on information associated in a reliable manner with the physical location, e.g., residence, from which a transaction is originated.

### SUMMARY OF THE INVENTION

Methods and apparatus which support and facilitate fraud detection and/or detection of discrepancies between customer provided information and reliable information corresponding to a customer are described. The methods and apparatus are particularly well suited for Internet and/or other E-commerce transactions.

In various embodiments, detection of fraud and/or discrepancies in customer provided information as compared to a set of previously stored information are identified with the assistance of a network service provider, e.g., internet service provider (ISP). The methods and apparatus of the present invention can be used to detect and/or mitigate online payment frauds, e.g., credit card online payment frauds. The methods and apparatus allows a payment processing service provider device, e.g., credit card and/or debit card provider device used to implement a credit or debit transaction, to obtain assistance from a network service provider, e.g., an ISP, in verify authenticity of a payer based on information provided during a payment transaction and thus detect a possibility of online fraud.

In addition, in at least some but not all embodiments, in the event of a fraudulent transaction and/or discrepancies, the ISP can provide information on the physical location from which the fraudulent transaction originates. This information can, and in some embodiments is, used to facilitate the detection of criminal activity and, in some embodiments, the reporting of such activity to law enforcement officials. While, in some embodiments, a single erroneous transaction may not result in a fraud report being generated and sent to law enforcement or policy enforcement entities, a repeated pattern of fraudulent transactions by the ISP provider may trigger an alert due to a pattern of activity which might not be visible to the individual sellers who encounter an attempt by an entity to pay using fraudulent or stolen information.

In accordance with some exemplary embodiments, a payment company, e.g., a credit card/debit card provider or other entity, as part of a transaction authorization, sends a verification request in the form of a query to a customer's ISP with some information corresponding to the payer/customer requesting the transaction (e.g. name, billing address, etc.) and the source IP address the customer is using for the transaction, e.g., the source IP address of packets sent from the customer device as part of the transaction. The source IP address is used by the ISP provider, e.g., a server operated by the ISP provider, to identify a device and/or physical location using the IP address and a customer record corresponding to the device, e.g., as identified by a MAC address and/or physical location, e.g., customer premise, using the IP address. In various embodiments this is done in real time before a transaction is completed. However, non-real time embodiments are also possible.

In at least some embodiments the ISP returns a “matching score” based on how well the customer information provided to the customer's ISP matched the ISP's customer information associated with the source IP address. While in some embodiments the information being verified may include a credit card number which may be stored in a customer record corresponding to the customer, in other embodiments credit card or bank account information is not included and the verification is performed to verify other information, e.g., an address, name, customer age, personal identification number, and/or other information which may be stored in the customer record identified and accessed based on the provided IP address. Thus, the verification server may verifying that customer information matches customer information already on record for a customer corresponding to the supplied IP address. While some of the information stored in the customer record, e.g., a verification code or PIN used to authorization transactions, credit card and/or bank information other information may be entered in the customer record by the ISP provider and, in fact, some of the information such as the address corresponding to the customer which is stored in the customer record may have been in fact verified by a person working for the ISP provider, e.g., at the time of installation or activation of ISP service. Thus, at least in some cases, some of the customer information which is accessed and compared to the information provided to the ISP's verification server as part of a verification operation was independently verified by the ISP provider and/or another entity such as a company or staff working for the ISP provider.

In various embodiments the matching score indicates how closely the payer information matches the customer information. In some embodiments the ISP sends information indicating which of a plurality of information fields, e.g., one or more of a first name field, a last name field, a middle initial name field, a street address field, a town field, a zip code field etc. included in the payer information received from the payment service company, fail to match corresponding information fields in an identified customer record. Thus, while a seller may receive a matching score and/or information specifying which fields include errors, the actual customer's information is not provided to the seller in some embodiments.

While in some embodiments information about which fields do not match the stored information is provided to a party seeking information verification, in other embodiments only a matching score is returned. In at least some such embodiments to make it harder for an entity, e.g., a party seeking verification of information, to use the verification process as a method of determining and/or identifying which particular fields supplied to the verification server include errors, a top matching score does not necessarily indicate a perfect match. For example, in some embodiments a very high score may indicate a perfect match or a match of some fields with one, and in some cases a few, information mismatches. A high score may indicate one or more than one mismatch but still a low number of information mismatches. A low score may indicate a large number of information miss-matches. By intentionally introducing some ambiguity into the results indicated by the score it is much harder for an entity to use the verification system of the present invention to determine or confirm a particular piece of information through trial and error and a number of verification requests corresponding to the same IP address. In some embodiments the receipt of multiple verification requests with errors, e.g., a number over a predetermined threshold number used to trigger a security operation, corresponding to the same IP address or coming from the same source triggers a security operation such as denial of further verification requests for the entity requesting verification and/or notification of the customer to which the IP address corresponds of a potential attempt to assume the user's identity, make unauthorized purchases and/or otherwise make purchases which may not have been authorized by the customer. This can be useful when a house guest, maid or other person gains access to a customer's customer premise equipment and trys to make unauthorized purchases using information which may not correspond to the information stored in the customer record maintained by the ISP.

In various embodiments, the payment processing company decides how to proceed, e.g., deny or approve the payment transaction, based on the matching score and/or other comparison information provided by the ISP.

In some embodiments the payment processing company chooses to proceed with the transaction if the comparison result indicates a sufficiently high matching score.

In other embodiments the payment processing company chooses to proceed if at least some of the information fields, e.g., last name, street address, and telephone number, in the payer information and the customer record match. The score and/or number of matching fields required by the seller for completion of the transaction may be a function of the total dollar amount of the transaction involved.

In some other embodiments the payment processing company chooses to proceed with the transaction only if the comparison result indicates that all of the information fields in the payer information and the customer record match, i.e., as indicated by a score indicating a perfect match or some other indication.

An exemplary fraud prevention method, in accordance with some embodiments, comprises: receiving payer information and an IP address from a payment processing service; identifying a customer record corresponding to the IP address; determining how closely the payer information matches customer information included in the identified customer record; and sending information to said payment processing service indicating how closely the payer information matches customer information included in the identified customer record.

While the information verification methods of the present invention are described in the context of a financial transaction, they may be used in non-financial contexts as well to verify information, e.g., information supplied by someone using an IP address and or device which uses an IP address. For example, the methods and apparatus of the present invention can, and in some embodiments is, used to verify address, name and/or information supplied to someone as part of an IP communication. In such a case the party or entity seeking verification of the information sends the information as part of a verification request to the ISP provider system along with the IP address of original sender of the information. The verification request may and sometimes does include the IP address of the party or entity seeking the verification allowing the IP system to response to the request via IP communication. This can be useful for dating services and/or people setting up meeting to verify that the person, business and/or entity they are interacting with is not providing false information as to location, name, age or any other information that can be verified using information stored in the customer record maintained by the ISP provider.

Various additional features and advantages of the present invention are discussed in the detailed description which follows.

### BRIEF DESCRIPTION OF THE DRAWINGS

FIG. 1 illustrates an exemplary system implemented in accordance with some embodiments of the present invention.

FIG. 2 illustrates signaling performed in accordance with one exemplary embodiment implemented using the system shown in FIG. 1.

FIG. 3 illustrates an exemplary IP address-device identifier record in a tabular form, which is maintained by an exemplary ISP IP server, in accordance with some embodiments.

FIG. 4 illustrates an exemplary customer record including customer information corresponding to a plurality of ISP customers.

FIG. 5 is a drawing of an exemplary matching engine implemented in accordance with an exemplary embodiment of the invention.

### DETAILED DESCRIPTION

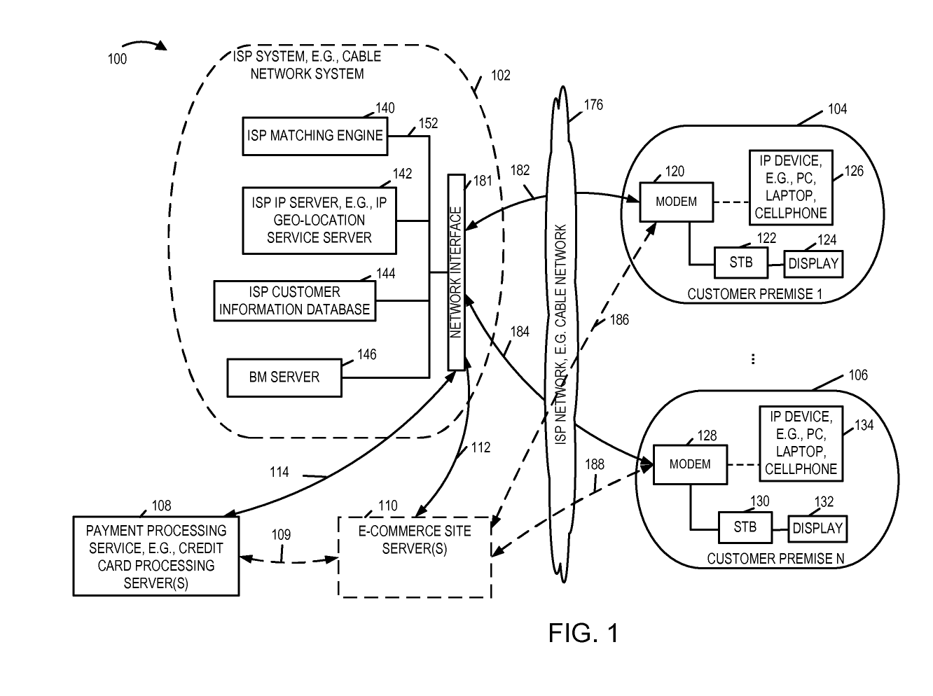

FIG. 1 illustrates a system 100 implemented in accordance with some exemplary embodiments of the present invention. The system 100 supports content delivery, e.g., video and audio content delivery, customer premise equipment (CPE), e.g., set top box, IP devices, e.g., Personal Computers (PC), laptops, cell phones, etc. The system 100 includes a internet service provider system 102, e.g., cable network system, a ISP network 176, e.g., a cable network, a plurality of customer premises 104, 106, a payment processing service, e.g., credit card processing server(s) 108, and E-commerce site server(s) 110. In the discussion, ISP system 102 is sometimes referred to as headend 102. The IP devices at a customer premise (CP) may be a device that supports internet protocol such as a personal computer (PC), laptop, cell phone, etc. In various embodiments the cell phones support web browsing functionality and other features useful in, e.g., purchasing online, e.g., over the internet, from various e-commerce websites.

The ISP system/headend 102 may be implemented at an internet service provider's office or site including multiple servers and databases which are coupled together. In the FIG. 1 example, the ISP system 102 includes an ISP matching engine 140, an ISP IP server 142, e.g., a geo-location service server, an ISP customer information database 144, and a business management server 146. The various servers and other components included in the ISP system 102 are coupled together by a local network 152. The local network 152 is coupled via one or more network interfaces 181 to other networks and/or devices. For example, the ISP system 102 is coupled via network interface 181 to ISP network 176, e.g., a cable network, and may also be coupled to one or more other external networks.

Via ISP network 176, the devices in the network headend 102 can send and receive signaling and/or other information to the devices located at the customer premises 104, 106 coupled to the cable network 176. Each customer premise 104, 106 includes a set top box 122, 130 and a display device 124, 132 which could be, e.g., external television. It should be appreciated that each of the STBs 116, 124 can be integrated in a device which also includes a display. The STBs support video and, optionally, E-mail functionality. The STBs 116, 124 can be used to send information to the ISP system/headend 102 in addition to receiving signaling and/or information from the ISP system 102. In addition, each customer premise 104, 106 includes a cable modem 120, 128, and a user IP device 126, 134. The STBs and the user IP devices are coupled to the cable modem 120, 128.

As shown in FIG. 1, communications link 182 traversing the service provider's cable network 176 couples cable modem 120 to the network head end 102's network interface 181. Similarly, cable modem 128 in the customer premise n 106 is coupled to ISP system 102's network interface 181 via link 184 which traverses ISP network 176. In various embodiments, one or more customer premise devices, e.g., STBs and/or IP devices, have the capability to exchange information and make transactions with other external servers, e.g., E-commerce server(s) 110, online, e.g., over the ISP network 176. The STBs 122, 130 may, and often do, include DVR functionality and the storage of user selected content. The STBs can be used to send information, e.g., an online transaction/purchase request, to one or more e-commerce website servers 110 over the ISP network 176 in addition to receiving programming content, E-mails, updates etc., from the ISP system 102. Although not shown, customer premise 104, 106 may also include additional STBs and display devices. In some embodiments the STBs 122, 130 include a built in cable modem.

In FIG. 1, for simplification, e-commerce site servers 110 are shown as a collective group of servers corresponding to one or more e-commerce websites, e.g., retailer websites that support online sale, purchase and/or both, however individual e-commerce servers corresponding to various individual e-commerce websites (retailer's website) may be present in some embodiments and are supported. As will be discussed below, the e-commerce site servers 110 are capable of responding to online purchase requests, e.g., online purchase request/order, received from STBs, IP devices and/or other customer premise devices that support internet browsing. When a customer wishes to buy an item, e.g., product/service, online from a e-commerce website, the customer places the order for the item using device that supports making such transactions over the internet, e.g., such as the STBs 122, 130, IP devices 126, 134 located at the customer premises 104, 106. The order is sent to the e-commerce website server corresponding to the retailer's e-commerce website and is processed further before the transaction can be completed.

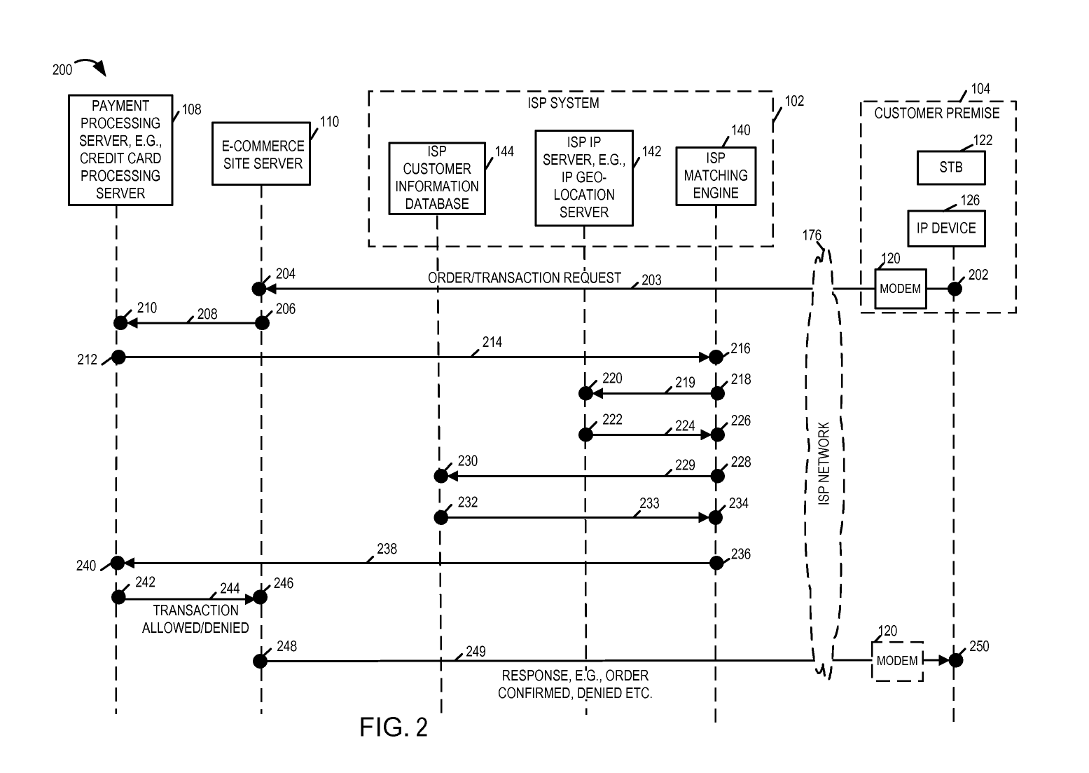

The credit card processing servers 108 are examples of one or more payment processing service devices or entities corresponding to, e.g., bank, retailer, and/or other financial or credit service provider with which the customer placing the order has a relationship, e.g., customer holds an account with the bank, retailer, and/or other financial or credit service provider. For example, the credit card processing servers 108 may include credit/debit card payment processing servers corresponding to a plurality of banks, stores, retailers, and/or other financial or credit service providers where the customer, making the online purchase, has an account. The servers 108 may, and in some embodiments do, initiate information verification requests as part of a customer transaction. The information verification requests may be in the form of one or more messages sent to a verification server, e.g., ISP information matching engine 140 shown in FIG. 2.

Referring again to the ISP system 102. The ISP matching engine 140 is responsible for matching and comparing customer information provided by an external payment processing server, e.g., credit card processing server 108, with the customer information associated with a customer's account stored in the ISP customer information database 144. In some embodiments the information provided by the external payment processing server includes at least one of customer's name, home address and/or billing address, source IP address that the customer is using during the online payment transactions, e.g., while placing the online order.

The ISP customer information database 144 includes, for a plurality of customers, customer information, account information and information regarding the devices installed at customer premises. In some embodiments customer account information includes, e.g., customer account number, customer subscription/service information, customer device capability and other billing related information. ISP customer database 144 also includes customer device information, e.g., identification and/or other information regarding customer devices such as STBs, cable modems etc., installed at various customer premises served by the ISP system 102. In some embodiments the customer device information includes, for example, physical device identifiers and/or MAC addresses corresponding to the STBs and cable modems installed at customer premise 104, 106.

At a given time there is an IP address assigned by the ISP to a customer premise device, such as the cable modem, STB, that enables the customer to gain access to the ISP network services, e.g., internet. In various embodiments at a given time there is clear mapping between an IP address assigned to the customer premise device, e.g., cable modem 120, and the customer information stored in the ISP customer database 144, e.g., customer's name, billing address, home address, account number.

The ISP IP server, e.g., IP geo-location service server 142, tracks and maintains a record regarding the IP addresses which have been assigned to various different customer premise devices at a given time along with device identification information corresponding to these various different customer premise devices. Thus the IP geo-location service server 142 maintains a record where source IP address currently being assigned to a customer premise device, e.g., cable modem, is mapped to a unique identifier corresponding to the cable modems installed at the customer premise. In some embodiments the unique identifier corresponding to a customer premise device is, e.g., a MAC address, associated with the device. The record maintained by the IP geo-location service server 142 is updated in real time, e.g., whenever there is a change in the source IP address assigned to a given customer premise device and/or there is a change in the customer premise device itself, for example when the cable modem is replaced with another cable modem having a different unique identifier.

BM (Business management) server 146 processes billing information corresponding to customers serviced by the ISP system 102. This may include updating billing charge information in response to changes in services being provided to the customer, upgrades, new purchases, and/or other activity. Business management server 146 also processes services bill payment information, e.g., bill payment transactions, deductions from debit accounts, mail bills, and/or processes discount and/or other information.

Having generally discussed the exemplary system shown in FIG. 1, an exemplary method will now be discussed in detail with regard to the example shown in FIG. 2. Elements of the system 100 shown in FIG. 1 which participate in the method being described in the FIG. 2 example are shown at the top of FIG. 2 and bear the same reference numbers as used in FIG. 1. Messages, information, content and/or signals communicated between devices are represented in FIG. 2 using arrows. The exemplary process shown in FIG. 2 will now be described in detail.

At the top of FIG. 2, various elements 200 of the system 100 which may participate in online payment authentication and/or authorization in accordance with one embodiment of the invention, are shown. The illustrated components 200 include a cable modem 120, STB 122, customer's IP device 126, ISP system 102 including the matching engine 140, ISP IP server 142, and ISP customer information database 144, e-commerce site server(s) 110, and the payment processing service server, e.g., credit card processing server 108.

FIG. 2, illustrates the steps and associated signaling used in one exemplary embodiment where a customer, located at a customer premise, e.g., CP 104, attempts to make an online transaction and initiates an e-commerce transaction, e.g., places an order online to purchase an item. It should be appreciated that the customer at customer premise 104 may use any device coupled to the cable modem 120, e.g., IP device 126 (e.g., a PC), STB 122, for placing an order to buy an item online through an e-commerce website, e.g., such as e-bay.com, amazon.com, walmart.com etc.

The process starts in step 202 where the customer places the order, e.g., submits a request to buy the item. Such orders are handled and processed by the e-commerce site server 110. This is illustrated in FIG. 2 by signal 203 which indicates that a request to purchase the item is sent (over the ISP network 176, e.g., internet) to the e-commerce site server 110. It is understood that as part of placing the order the user enters credit card/debit card number and/or other payment information to pay for the item being purchased and payer information corresponding to the payer, e.g., individual responsible for paying for the purchased item, including one or more of, e.g., payer/customer name, home address, billing address, e-mail address, telephone number etc. Thus in various embodiments the purchase request/order includes, among other things, payment information, payer information such as location information, name and/or address. Normally the customer making a purchase is also the payer.

The e-commerce site server 110 receives and processes the signal 203 including the order and payment information in step 204. In accordance with one feature, the e-commerce site server 110 retrieves, from the received signal 203 the IP address corresponding to the customer device via which the order has been sent over the network, e.g., IP address of the cable modem 120, STB 122. For discussion purposes, consider that the IP address corresponds to the cable modem 120. In accordance with one feature of the invention, in step 206 the e-commerce site sends a payment request 208 to the payment processing service, e.g., the credit card processing server 108. In some embodiments the payment request 208 includes (i) payment information, e.g., credit card/debit card information and/or other information, (ii) at least some payer information, and (iii) the source IP address, i.e., IP address corresponding to the cable modem 120, retrieved by the e-commerce site server 110.

It should be appreciated that the IP address corresponding to the customer device is sent to the credit card processing server 108 in addition to other payment related information in order to detect and mitigate a possibility of an online fraud in accordance with one feature of the invention. The credit card processing server 108 receives the payment request 208 in step 210. In some embodiments the at least some payer information includes full or a subset of the payer's information received in the purchase request 203. It should be appreciated that in various embodiments the payer information is received by said payment service as part of an e-commerce transaction using said IP address.

In accordance with one aspect of the invention, prior to approving the transaction requested by the e-commerce site server 110 and charging the payer's credit/debit card for the purchase, the credit card processing server 108 performs one or more verifications to check and ensure that the transaction is not fraudulent. In some embodiments, as part of the verification process, the credit card processing server 108 sends a verification request 214 including at least some payer information and the source IP address to the ISP system 102. In various embodiments, the verification request 214 is received and processed by the ISP matching engine 140 in step 216.

The matching engine 140 processes the verification request and retrieves the source IP address corresponding to the cable modem 120 communicated in the verification request 214. In various embodiments the IP address received from the payment processing service, e.g., credit card servers 108, is the IP address used to initiate the payment transaction, as discussed in step 202. In various embodiments said IP address is a dynamically assigned IP address which was assigned by the internet service provider (ISP system 102) for use by the customer premise device, e.g., cable modem 120, STB 122.

Next in step 218, the matching engine 140 sends an identification request 219 including the source IP address associated with the cable modem 120 to the ISP IP geo-location server 142. As discussed earlier, the ISP IP geo-location server 142 maintains a record that indicates for a plurality of customers, an IP address currently being assigned to a customer premise device, e.g., cable modem, and a unique device identifier corresponding to that customer device installed at the customer premise. The IP geo-location server 142 receives the identification request 219 in step 220. In step 220 the IP geo-location server 142 performs a look-up and identifies the unique device identifier, e.g., MAC address, corresponding to the cable modem 120 for which the source IP address has been communicated in the identification request 219.

The IP geo-location server 142 determines if a device identifier that maps to the received source IP address exists in the record. After performing the determination, the IP geo-location server 142 sends, in step 222, an identification response signal 224 back to the matching engine 140. If it is determined that there is a device identifier corresponding to the source IP address, the identification response signal 224 indicates the identified unique device identifier that maps to the received source IP address corresponding to the cable modem. Thus the identification response signal 224 communicates the device identifier, e.g., MAC address, of the cable modem 120. However if it is determined that there is no device identifier mapping to the source IP address, the identification response signal 224 indicates that there is an error and no match to the source IP address is found. The identification response signal 224 is received by the matching engine 140 in step 226.

In some embodiments if the identification response signal 224 returns a device identifier corresponding to the customer device, then steps 228, 230, 232 and 234 are performed and not otherwise. If the identification response signal 224 indicates an error or that no mapping device identifier is found, steps 228, 230, 232 and 234 are not performed and the operation proceeds to step 236. For the purpose of discussion, consider that the identification response signal 224 received in step 226 communicates the MAC address, corresponding to the cable modem 120.

Following the receipt of the identification response signal 224, in step 228 the matching engine 140 sends a query 229 requesting customer information associated with the device identifier corresponding to the cable modem 120, to the ISP customer information database 144. The ISP customer information database 144 receives and processes the query 229 in step 230. Next in step 232 the ISP customer information database 144 returns the customer information associated with the device identifier corresponding to the cable modem 120 in a signal 233 to the matching engine 140 which is received in step 234. Following the receipt of the customer information from the customer database 144, the matching engine 140 performs a matching operation by comparing the customer information returned by the customer database 144 to the at least some payer information received from the credit card processing server 108 earlier in step 216. The matching engine 140 generates a matching score based on how well the two sets of information, i.e., payer information and customer information match. In some embodiments various types of information fields included in the two sets of information received by the matching engine 140 are compared to generate the score.

In step 236 the matching engine 140 sends the generated matching score to the credit card processing server 108 as indicated by arrow 238. The credit card processing server 108 receives the score in step 240 and performs processing in order to complete the authentication process. In some embodiments the matching engine 140 sends the result of matching operation indicating how closely the payer information matches the customer information to the credit card processing server 108. In some embodiments the matching engine 140 sends a message indicating which of a plurality of information fields, e.g., one or more of a first name field, a last name field, a middle initial name field, a street address field, a town field, a zip code field, telephone number field, etc. included in the payer information match or failed to match corresponding information fields in the identified customer information.

Using the received score or the comparison result, the credit card processing server 108 determines potential of fraud, e.g., a probability the online payment transaction is fraudulent. The payment processing service can then decide whether or not to proceed with the transaction based on the indicated matches/mismatches. For example the credit card processing servers 108 may choose to proceed with the transaction if the last name, street address, and telephone number are correct even if the first name and middle initial are wrong as may be the case when another family member places an order.

If the credit card processing server 108 determines that the online order is potentially a fraud, then in step 242 the credit card processing server 108 denies authorizing the transaction and sends a signal 244 indicating that the transaction has been denied, to the e-commerce website server 110. If it is determined that the online order is valid and/or that the potential for fraud is below a predetermined level, then in step 242 the credit card processing server 108 authorizes the transaction and indicates in signal 244 that the transaction has been approved.

The e-commerce site server 110 receives the authorization approval/denial 244 is step 246. Based on what the approval/denial signal 244 indicates, the e-commerce site server 110 generates a response message 249 in response to the order/transaction request 203, for sending to the customer's device IP device 126.

In step 248 the e-commerce site server 110 sends the response message 249 to the customer device 126. If the payment transaction has been approved by the credit card processing server 108, the e-commerce site server 110 sends the response message 249 indicating that the customers order has been placed/confirmed. In some embodiments the response message 249 includes a confirmation number associated with an approved order. For example, the customer may receive the following message displayed on the device display screen “THANK YOU. YOUR ORDER IS CONFIRMED. YOUR CONFIRMATION NUMBER IS XYZ1231212”. In the event when the payment transaction has been denied by the credit card processing server 108, the e-commerce site server 110 sends the response message 249 indicating that the customers order has been denied. In such a case, in some embodiments the response message 249 includes a denial code and a message is displayed on the device display screen “SORRY. YOUR ORDER CANNOT BE COMPLETED. PLEASE CONTACT YOUR CREDIT/DEBIT CARD PROVIDER. YOUR DENIAL CODE NUMBER IS YXY12345”. In case of the denied transaction, a legitimate customer may contact the bank and/or other credit/debit card provider to find the reason of denial.

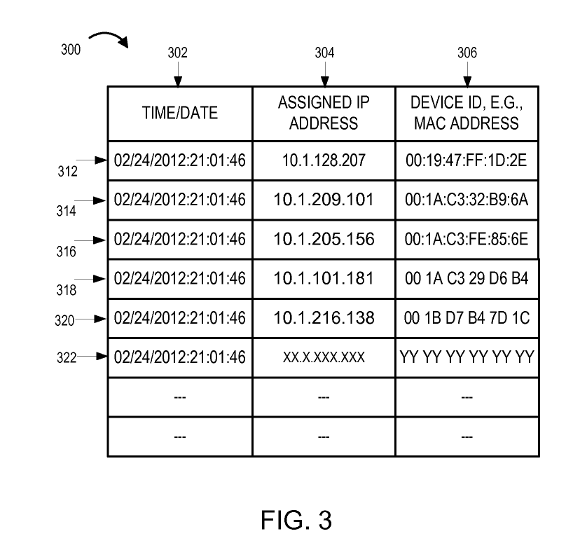

FIG. 3 illustrates an exemplary record 300 in a tabular form, which is maintained by the ISP IP server 142, e.g., IP geo-location server, in accordance with some embodiments. The exemplary record 300 includes information regarding the current IP addresses assigned to various customer premise devices, e.g., cable modems, located at various customer premises.

Each entry in column 302 of table 1300 identifies date and time, e.g., a current date and time. Each entry in column 304 of table 1300 identifies an IP address that is currently assigned to the customer device identified by a device identifier indicated in the corresponding entry in column 306. The time stamps in column 302 not only indicates the current date and time but also confirms that at the indicated time, the IP address in the corresponding entry in column 304 remains assigned to the customer device identified by a device identifier indicated in the corresponding entry in column 306. The device identifier in the illustrated example of FIG. 3 is e.g., a MAC address of the customer equipment, e.g., cable modem, via which the customer is able to access the ISP network and connect other customer devices such as the STBs, laptops, PC etc.

As an example consider the first row 312 of table 300 which includes first entry from each of the columns in the table 300. The information shown in row 312 indicates that at the time and date identified as 2/24/2012: 21:01:46 hours, the IP address “10.1.128.207” is found to be assigned to a customer device having a unique device identifier (e.g., MAC address) “00:19:47:FF:1D:2E”. The table 300 may be generated, e.g., by the IP geo-location server 142, as part of a process of tracking the IP addresses currently being used by various customer devices during various sessions. In accordance with one aspect of some embodiments, the IP geo-location server 142 uses the record 300 may be, and in some embodiments, is used by the geo-location server 142 to respond to the identification request from the matching engine 140 to identify a customer premise device to which a particular IP address is assigned at a given time.

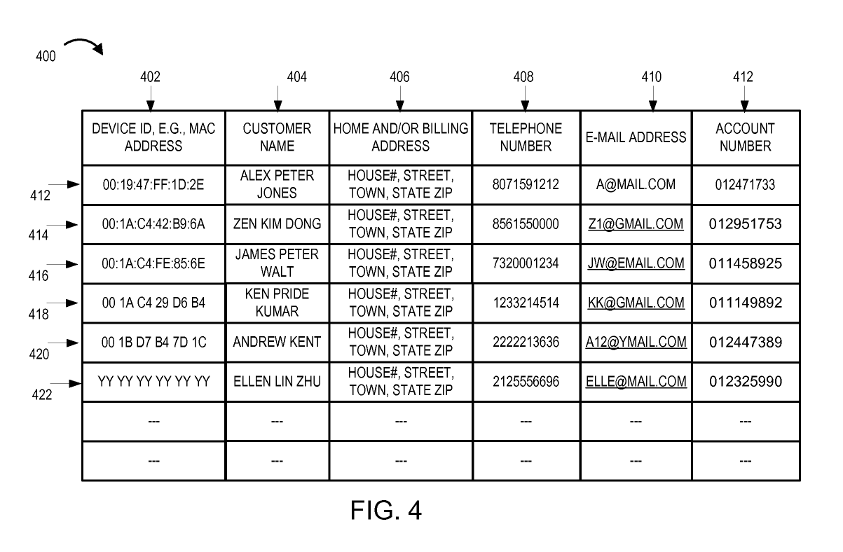

FIG. 4 illustrates exemplary customer record table 400 including customer records corresponding to a plurality of ISP customers. The customer record table 400 may be used to match information corresponding to particular customers. The customer record table 400 is a customer information table stored, in some embodiments, in the ISP customer information database 144 along with other additional sets of information corresponding to the ISP customers. Each row in the customer record table 400, indicated by reference numbers 412 through 422, represents a customer record including customer information corresponding to a particular customer. Each entry in column 402 indicates a unique device identifiers corresponding to a customer premise device, e.g., cable modem, installed at the customer premise of that particular customer identified by the name in the corresponding entry in column 404. Each entry in column 404 includes a customer's first, middle and last name (shown in that order). Each entry in column 406 indicates the home and/or billing address for the corresponding customer while each entry in column 408 indicates the telephone number associated with the customer's account. Each entry in column 410 indicates an e-mail address for the corresponding customer while each entry in column 412 indicates the account number assigned by the ISP to the corresponding customer. In some embodiments the home and/or billing address for a customer shown in column 406 is the address of the customer premise where the customer device, identified in a corresponding entry in column 402, is installed.

In accordance with one feature of various embodiments, the ISP matching engine 140 uses a device identifier corresponding to a customer device, e.g., cable modem, to query the ISP customer information database 144, to seek the customer information associated with the device identifier. The ISP customer information database 144 is configured to respond to the query with the customer information corresponding to that device identifier. For example, the ISP matching engine may seek information regarding the customer associated with device identifier “00:19:47:FF:1D:2E”. The ISP customer information database 144 performs a lookup and retrieves a customer record corresponding to the customer associated with the customer device identifier “00:19:47:FF:1D:2E”, indicated in row 412 of record 400, and sends at least some of the customer information shown in row 412 back to the ISP matching engine 140 in a response message.

In various embodiments the matching engine 140 matches/compares the customer information received from the customer information database 144 to the customer information received from the credit card processing server 108. Although not shown in FIG. 4 example, in some embodiments the customer record 400 also includes a plurality of credit card records, said credit card records including credit card information and related customer information provided by a customer to which the customer record corresponds.

In some embodiments the customer to which the identified customer record corresponds can set a control field corresponding to each credit card record indicating whether credit card record information can be used to verify payment transactions or not. For example, may be some credit cards can be authorized for e-commerce transactions while another credit card might not be authorized for e-commerce transactions but instead for charging of the monthly cable service bill.

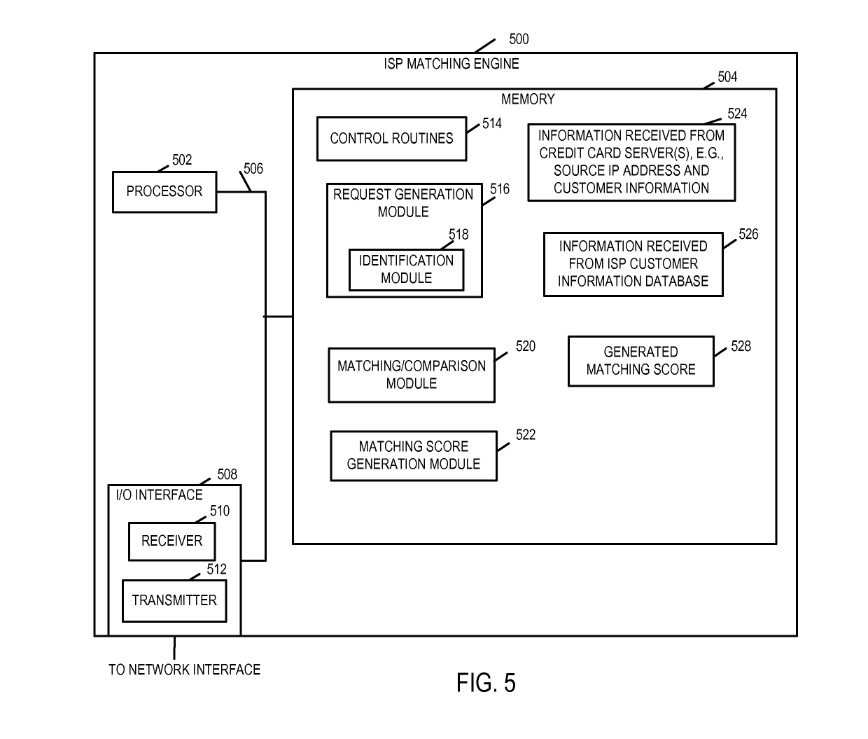

FIG. 5 is a drawing of an exemplary matching engine 500 which may be used as the matching engine 140 of FIG. 1, in accordance with an exemplary embodiment of the invention.

As illustrated, the matching engine 500 includes a processor 502, an I/O interface 508, and a memory 504 coupled together by a bus 506. The I/O interface 508 includes a receiver 510 and a transmitter 512. The receiver 510 is responsible for receiving and processing messages, replies, control signals, and/or other information, content, e.g., image and audio content. The transmitter 512 is configured to generate and transmit messages, signals, replies and/or other information. In some embodiments, both the receiver 510 and transmitter 512 work under direction of the processor 502 which executes one or more of the routines and/or modules included in memory 504 to control the operation of one or more elements in the matching engine 500 in accordance with the invention. For example, the receiver 510 is used for receiving a verification request including payer information and IP address corresponding to a customer device, from a payment processing service, e.g., credit card processing server 108. Thus, via the I/O interface 508, the matching engine 500 can receive and/or transmit signals, e.g., messages, commands, and/or other information, from one or more other devices. The matching engine 500 receives and sends signals, over the ISP network 176.

The memory 504 includes control routines 514 which control overall matching engine 500 operation in accordance with the invention. Control routines 514 may operate in conjunction with various modules which are used to perform various functions. Modules included in the memory 504 include a request generation module 516, a comparison module 520, and a matching score generation module 522. The memory 504 further includes information received from one or more credit card servers 524, information received from ISP customer information database 526, and generated matching score 528, e.g., corresponding to one or more customers. The generated matching score 528 is an output of matching score generation module 522. The information 524 includes information, e.g., source IP address and customer information received from one or more credit card processing servers 108, for the purposes of matching and/or authentication.

The request generation module 516 further includes an identification module 518. The request generation module 516 generates an identification request, e.g., such as identification request 219, to identify a customer device associated with an IP address. The identification request includes the source IP address associated with a customer premise equipment, e.g., such as the cable modem 120. The request generation module 516 is configured to include the source IP address received from the credit card mapping server 108, in the generated identification request. As discussed earlier, the generated identification request is sent to the ISP IP server, e.g., IP geo-location server 142, which maps the source IP address to a unique identifier, e.g., MAC address, corresponding to the customer device associated with the source identifier. The ISP IP server 142 performs a look-up and identifies the unique device identifier corresponding to the customer device for which the identification request has been sent. In various embodiments the identification module 518 is configured to receive an identification request response, received via the receiver 510, from the ISP IP server 142 and recover the device identifier, e.g., MAC address, corresponding to the customer device for which the identification was requested.

In some embodiments the request generation module 516 is further configured to generate a request for customer information, e.g., request 229, to seek customer record corresponding to a customer device identifier. The request for customer record is sent to the customer information database 144. In various embodiments the request generation module 516 includes the recovered customer device MAC address, received from the IP geo-location server 142, in the generated request for customer information 229. The identification module 518 is further configured to receive a customer record request response, e.g., response 233, from the ISP customer database 144 and identify the customer record corresponding to the customer corresponding to the IP address.

The comparison module 520 is configured to perform a matching operation, using the receive payer information from the credit card processing server 108 and the customer information received from the ISP customer database 144. In some embodiments the payer information received from the credit card processing server 108 includes a plurality of information field including one or more of a payer name (e.g., first, middle, last name), payer home address and/or billing address including zip code, e-mail address, telephone number. In some embodiments the customer information received from the ISP customer database 144 includes a device identifier, MAC address, of the customer device installed at customer premise, customer name (e.g., first, middle, last name), customer home address and/or billing address including zip code, e-mail address, telephone number, customer account number, customer service package information, etc. In various embodiments the comparison module 520 is configured to compare/match each information field in the received payer information to each corresponding information field in the received customer information, e.g., payer first name compared with customer first name, last name with last name, payer home and/or billing street address with customer's home and/or billing street address, etc. The comparison module 520 provides the result of the matching operation to the matching score generation module 522 which generates a matching score 528 indicating how closely the received payer information matches the customer information in the customer record. In some embodiments the score indicates how well the various fields of payer information match the corresponding information fields in the identified customer record. In various embodiments a higher generated matching score 528 indicates more closely and accurately matching payer and customer information fields.

In some embodiments the comparison module 520 is configured to send, e.g., via the transmitter 512, the result of comparison indicating how closely the payer information matches the customer information to the credit card processing server 108. The comparison module 520 sends a message indicating which of a plurality of information fields, e.g., one or more of a first name field, a last name field, a middle initial name field, a street address field, a town field, a zip code field, telephone number field, etc. included in the payer information matches or fails to match corresponding information fields in the identified customer information. A match or mismatch indication is provided in some embodiments, for at least some fields, to the credit card processing servers 108 on a per field basis, without disclosing to the payment processing service, e.g., credit card processing servers 108, the actual information on the customer record. The payment processing service can then decide whether or not to proceed with the transaction based on the indicated matches/mismatches.

An exemplary fraud prevention method, in accordance with some embodiments, comprises: receiving payer information and an IP address from a payment processing service; identifying a customer record corresponding to the IP address; determining how closely the payer information matches customer information included in the identified customer record; and sending information to said payment processing service indicating how closely the payer information matches customer information included in the identified customer record. In some embodiments said payment processing service is a credit card processing service. In some embodiments payer information is received by the payment processing service, e.g., credit card/debit card processing server, as part of an e-commerce transaction using said IP address.

In some embodiments identifying a customer record corresponding to the IP address includes providing the IP address received from a payment processing service to an Internet Service Provider server; and receiving, from said Internet Service provider server, device identification identifying a customer premise device corresponding to an Internet Service Provider customer. In some embodiments the device identification information is a MAC address of said customer premise device. In some embodiments identifying a customer record includes using the MAC address to identify a customer record corresponding to said MAC address.

In some embodiments the IP addressed received from a payment processing service is an IP address used to initiate a payment transaction. In some embodiments the IP address is a dynamically assigned IP address which was assigned by said Internet Service Provider for use by said customer premise device. In some embodiments the customer premise device is one of a cable modem and set top box.

In some embodiments determining how closely the payer information matches customer information includes comparing information in said received payer information to information in said customer record, and generating a score indicating how closely the received payer information matches the information in said customer record. In some embodiments sending information to said payment processing service indicating how closely the payer information matches the customer information includes sending the generated score to the payment processing service.

In some embodiments sending information to said payment processing service indicating how closely the payer information matches the customer information includes sending information indicating which of a plurality of information fields (e.g., one or more of a first name field, a last name field, a middle initial name field, a street address field, a town field, a zip code field,) included in the received payer information fail to match corresponding information fields in the identified customer record. (a match or mismatch indication is provided in some embodiments, for at least some fields, to the payment service on a per field basis without providing the payment service the actual information on record, the payment service can then decide whether or not to proceed with the transaction based on the indicated matches/mismatches. For example the payment service may choose to proceed with the transaction if the last name, street address, and telephone number are correct even if the first name and middle initial are wrong as may be the case when another family member places an order.

In some embodiments the identified customer record includes a plurality of credit card records, said credit card records including credit card information and related customer information provided by a customer to which the customer record corresponds.

In some embodiments the customer to which the identified customer record corresponds can set a control field corresponding to each credit card record indicating whether credit card record information may be used to verify payment transactions. For example, some credit cards can be authorized for e-commerce transactions while another credit card might not be authorized for e-commerce transactions but instead for charging of the monthly cable service bill.

An exemplary apparatus which may be used in a fraud prevention system, in accordance with some embodiments, comprises: a receiver for receiving payer information and an IP address from a payment processing service; an identification module configured to identify a customer record corresponding to the IP address; a matching/comparison module configured to determine how closely the payer information matches customer information included in the identified customer record; and a transmitter for sending information to said payment processing service indicating how closely the payer information matches customer information included in the identified customer record. In some embodiments said payment processing service is a credit card processing service. In some embodiments payer information is received by the payment processing service, e.g., credit card/debit card processing server, as part of an e-commerce transaction using said IP address.

In some embodiments the identification module is configured to, as part of identifying a customer record corresponding to the IP address, provide the IP address received from a payment processing service to an Internet Service Provider server; and receive, from said Internet Service provider server, device identification identifying a customer premise device corresponding to an Internet Service Provider customer. In some embodiments the device identification information is a MAC address of said customer premise device. In various embodiments the identification module uses, as part of identifying a customer record corresponding to the IP address, the MAC address to identify a customer record corresponding to said MAC address.

In some embodiments the IP addressed received from a payment processing service is an IP address used to initiate a payment transaction. In some embodiments the IP address is a dynamically assigned IP address which was assigned by said Internet Service Provider for use by said customer premise device. In some embodiments the customer premise device is one of a cable modem and set top box.

In some embodiments the comparison module determines how closely the payer information matches customer information by comparing information in said received payer information to information in said customer record. The matching score generation module generates a score indicating how closely the received payer information matches the information in said customer record. In some embodiments the transmitter is configured to send, as part of sending information to said payment processing service indicating how closely the payer information matches the customer information, the generated score to the payment processing service.

In some embodiments the transmitter is configured to send, as part of sending information to the payment processing service indicating how closely the payer information matches the customer information, information indicating which of a plurality of information fields (e.g., one or more of a first name field, a last name field, a middle initial name field, a street address field, a town field, a zip code field) included in the received payer information fail to match corresponding information fields in the identified customer record. In some embodiments the transmitter is controlled by the comparison and/or matching score generation module, to send the information to the payment processing service indicating how closely the payer information matches the customer information.

In at least some but not all embodiments, in the event of a fraudulent transaction and/or discrepancies, the ISP can provide information on the physical location from which the fraudulent transaction originates. This information can, and in some embodiments is, used to facilitate the detection of criminal activity and, in some embodiments, the reporting of such activity to law enforcement officials. While, in some embodiments, a single erroneous transaction may not result in a fraud report being generated and sent to law enforcement or policy enforcement entities, a repeated pattern of fraudulent transactions by the ISP provider may trigger an alert due to a pattern of activity which might not be visible to the individual sellers who encounter an attempt by an entity to pay using fraudulent or stolen information.

In various embodiments system elements described herein are implemented using one or more modules which are used to perform the steps corresponding to one or more methods of the present invention, for example, receiving payer and/or customer information; identifying a customer device corresponding to an IP address, identifying a customer record corresponding to an IP address or customer device, determining how closely the payer information matches customer information in the customer record, and sending information to a payment processing service indicating how closely the payer information matches customer information.

In the above described methods, in some embodiments, each step may be performed by one or more different software instructions executed by a computer processor, e.g., a central processing unit (CPU). At least one system implemented in accordance with the present invention includes a means for implementing each of the various steps which are part of the methods of the present invention. Each means may be, e.g., an instruction, processor, hardware circuit and/or combination of elements used to implement a described step.

Many of the above described methods or method steps can be implemented using machine, e.g., computer, executable instructions, such as software, included in a non-transitory machine, e.g., computer, readable medium used to control a machine, e.g., general purpose computer with or without additional hardware, to implement all or portions of the above described methods, e.g., in one or more nodes. The machine readable medium may be, e.g., a memory device, e.g., RAM, floppy disk, etc. Accordingly, among other things, the present invention is directed to a machine-readable medium including machine executable instructions for causing a machine, e.g., processor and associated hardware, to perform one or more of the steps of the above-described method(s).

Numerous additional embodiments, within the scope of the present invention, will be apparent to those of ordinary skill in the art in view of the above description and the claims which follow.

What is claimed is:

1. A fraud prevention method, comprising:
receiving information and an IP address as part of an information verification request;
identifying a customer record corresponding to the IP address;
determining how closely the information matches customer information included in the identified customer record; and
sending information indicating how closely the received information matches customer information included in the identified customer record.

2. The fraud prevention method of claim 1,
wherein said information verification request is received from a payment processing service device or entity seeking information verification;
wherein identifying a customer record corresponding to the IP address includes:
providing the IP address included in said received information to an Internet Service Provider server; and
receiving, from said Internet Service provider server, device identification information identifying a customer premise device corresponding to an Internet Service Provider customer.

3. The fraud prevention method of claim 2,
wherein said device identification information is a MAC address of said customer premise device; and
wherein identifying a customer record further includes:
using said MAC address to identify a customer record corresponding to said MAC address.

4. The fraud prevention method of claim 3, wherein said IP addressed included in said received information is an IP address used to initiate a payment transaction.

5. The fraud prevention method of claim 4, wherein said IP address included in said received information is a dynamically assigned IP address which was assigned by said Internet Service Provider for use by said customer premise device; and
wherein said customer premise device is one of a cable modem and set top box.

6. The fraud prevention method of claim 1,
wherein said information verification request is received from a payment processing service provider device; and
wherein said payment processing service is a credit card processing service.

7. The fraud prevention method of claim 1, wherein determining how closely the payer information matches customer information includes:
comparing information in said received payer information to information in said customer record; and
generating a score indicating how closely the received payer information matches the information in said customer record.

8. The fraud prevention method of claim 7, wherein sending information to said payment processing service provider device includes:
sending the generated score to the payment processing service provider device.

9. The fraud prevention method of claim 7, wherein sending information to said payment processing service device includes:
sending information indicating which of a plurality of information fields included in the received payer information fail to match corresponding information fields in the identified customer record.

10. The fraud prevention method of claim 9, wherein said identified customer record includes a plurality of credit card records, said credit card records including credit card information and related customer information provided by a customer to which the customer record corresponds.

11. The fraud prevention method of claim 10, wherein said customer to which the identified customer record corresponds can set a control field corresponding to each credit card record indicating whether credit card record information may be used to verify payment transactions.

12. The fraud prevention method of claim 1, wherein said payer information is received by said payment service provider device as part of an e-commerce transaction using said IP address.

13. An apparatus for use in a fraud prevention system, comprising:
a receiver for receiving payer information and an IP address from a payment processing service;
an identification module configured to identify a customer record corresponding to the IP address;
a matching module configured to determine how closely the payer information matches customer information included in the identified customer record; and
a transmitter configured to send information to said payment processing service indicating how closely the payer information matches customer information included in the identified customer record.

14. The apparatus of claim 13, wherein said identification module is further configured, as part of being configured to identify a customer record corresponding to the IP address to:
provide the IP address received from a payment processing service to an Internet Service Provider server; and
receive device identification information identifying a customer premise device corresponding to an Internet Service Provider customer.

15. The apparatus of claim 14,
wherein said device identification information is a MAC address of said customer premise device; and
wherein said identification module uses said MAC address to identify a customer record corresponding to said MAC address.

16. The apparatus of claim 15, wherein said IP address is a dynamically assigned IP address which was assigned by said Internet Service Provider for use by said customer premise device; and
wherein said customer premise device is one of a cable modem and set top box.

17. The apparatus of claim 13, wherein said matching module is configured to compare information in said received payer information to information in said customer record as part of being configured to determine how closely the payer information matches customer information included in the identified customer record; and
wherein said apparatus further includes a score generation module configured to generate a score indicating how closely the received payer information matches the information in said customer record.

18. The apparatus of claim 17, wherein said transmitter is further configured to send the generated score to the payment processing service, as part of sending information to said payment processing service indicating how closely the payer information matches the customer information.

19. The apparatus of claim 17, wherein said transmitter is further configured to send information indicating which of a plurality of information fields included in the received payer information fail to match corresponding information fields in the identified customer record, as part of sending information to said payment processing service indicating how closely the payer information matches the customer information.

20. A non-transitory computer readable medium for use in an apparatus that facilitates online fraud prevention, said non-transitory computer readable medium comprising instructions which when executed by a processor control said apparatus to:
receive payer information and an IP address from a payment processing service;
identify a customer record corresponding to the IP address;
determine how closely the payer information matches customer information included in the identified customer record; and
send information to said payment processing service indicating how closely the payer information matches customer information included in the identified customer record.
